(19) United States
(12) Patent Application Publication
(10) Pub. No.: US 2007/0210211 A1
(43) Pub. Date: Sep. 13, 2007

(54) Airplane body and method for manufacturing it

(76) Inventor: Burkhart Grob, Bad Worishofen (DE)

Correspondence Address: JACOBSON HOLMAN PLLC, 400 SEVENTH STREET N.W., SUITE 600, WASHINGTON, DC, 20004, US

(21) Appl. No.: 11/703,206

(22) Filed: Feb. 7, 2007

(30) Foreign Application Priority Data
Feb. 7, 2006 (DE) 10 2006 005 755.4
Sep. 21, 2006 (DE) 10 2006 044 683.6

(51) Int. Cl. B64C 1/00

(52) U.S. Cl. 244/119

(57) ABSTRACT

The invention refers to an airplane body, in particular the fuselage, the fuselage being manufactured from a synthetic structure. The fuselage consists of at least two parts which are connected at the verges and enclosed by binders. The invention refers also to a method for manufacturing such an airplane.

### BACKGROUND OF THE INVENTION

The invention refers to an airplane body, in particular the fuselage, comprising at least two parts, manufactured preferably from synthetic material, wherein the parts are joined to each other at their edges. The invention also refers to a method for manufacturing such an airplane body.

Airplanes manufactured from synthetic material are already known. Here single parts of the airplane are manufactured in parts, and they are, after that, joined by glueing.

Recently airplanes of this type made from synthetic material are also used for long distance flights which arc carried out for economical reasons very high above which requires that for pilot and passengers a pressure cabin is provided. This pressure cabin must resist a pressure difference between the inside pressure and the considerably lower outside pressure in a relatively large height.

### SHORT ABSTRACT OF THE INVENTION

The invention is based on the problem to stabilise the airplane, in particular the fuselage of the airplane, in particular in the region of the pressure cabin.

According to the invention this problem is solved by providing the fuselage or the parts at least partly with a reinforcement.

According to the invention the problem is solved by the fact that an airplane body, in particular a fuselage, is suggested which consists of at least two parts preferably manufactured from synthetic material, wherein the parts are joined to each other at their edges, and the airplane body or the parts are provided at least partly with a reinforcement. The reinforcement suggested according to the invention has the effect to increase the stability of the airplane body. It has to be taken into consideration that the airplane for the air traffic in large heights is exposed to a pressure difference between outside skin and inside of about 0.6 Bar. This higher inside pressure blows up the airplane body, the reinforcement reaches a sufficient stabilisation. By means of the suggestion according to the invention it will be possible to use airplane bodies according to the invention also for planed which fly in heights above 3,000 meters. The field of use of airplane bodies from synthetic material, already known for gliders or light motor planes, is widened considerably by the suggestion according to the invention, and weight is saved. For that airplanes designed according to the invention have a larger range by the higher amount of fuel on board.

According to the invention it is provided here that the reinforcement runs angularly, in particular rectangularly, to the edge, and in particular reaches over the edges of the adjoining parts. The invention is here not restricted only to the suitable stiffening of the part forming the airplane, but stabilises and stiffens, respectively, also the link region at the verges of two adjoining parts accordingly. It is cleverly tried to achieve here that the reinforcement is, for example, guided annularly around the airplane body and thus leads to a stiffening.

As a possibility it is provided to sheathe the airplane body at least in the region of the pressure cabin. Also reinforcement fibers inserted in the material of the parts are possible. However, the reinforcements reaching across the verges can only be arranged with difficulties.

It has proofed to be in particular convenient to provide the parts of the airplane body on its outside with a casing so that by means of this casing the parts of the airplane body are kept together. In particular, according to a first embodiment, at least the pressure cabin is enclosed in certain distances radially by binders which do not only hold together the two parts of the airplane body at their verges but also reinforce the other region of the airplane body. Despite the high pressure in the pressure cabin the shape of the pressure cabin remains the same essentially. For example, the binders consist of fiber reinforced synthetic laminate where, in particular, carbon fibers are used as fibers. Also glass fibers or synthetic fibers are very well suited for reinforcing the laminate as they are very light weight, the same as carbon fibers, and can be strongly tension-loaded. By introducing aluminium fibers into the binders around the pressure cabin a so-called Faraday cage forms which protects the airplane against lightning.

The binder consist of stripes about five to twenty centimeters wide with a thickness of about one to five millimeters. At least in the region of the joined verges of the parts binder sections are arranged which the additionally hold together the glued seam. According to another embodiment the binders are put radially around the airplane body, and are connected to each other at their ends. Thus an annular design of the binders is created. For connecting these ends to one another, in particular, epoxy resin is suited as glue which has already been used for laminating the two parts of the airplane body. According to the invention it is convenient to use as glue for forming the binder the same glue as it has been used also in the manufacturing the part of the airplane body consisting of synthetic material. The binders are not only at their ends connected to each other but, by means of the epoxy resin, are also glued to the airplane body. The placing of the binders is thus stabilised. Thus slipping is impossible.

Besides these binders which surround the airplane body radially—called in the following radial binders—also binders are provided at the airplane body which are arranged transversely to the longitudinal axis of the airplane body. These transverse binders are clamped, for example, around the pressure ribs which close the pressure cabin at the front and back end. The ribs themselves are glued to the airplane body, and, for reinforcing the glue verges; reach across the transverse binders of the pressure ribs diagonally, are bent at the verges of the pressure ribs, and run across a certain range along the outside wall of the pressure cabin. The outside wall is, according to another embodiment, formed by the parts the airplane body consists of. Therefore it is convenient to guide the transverse binders covering the pressure ribs from the inside of the airplane body to the outside; for that purpose in the wall of the airplane body recesses are provided. These recesses are designed slot-like the dimensions of which are such that the binders can be easily guided through. At least on the outside of the airplane body the binders are glued with the fuselage. However, also in the region of the pressure ribs a glue connection reinforces the link between binder and pressure rib.

According to another embodiment the transverse binders can be guided across the entire length of the pressure cabin, and enclose the opposite pressure rib, wherein the transverse binder as also the radial binder are glued together at their ends, and thus encloses the pressure cabin completely in longitudinal direction to the longitudinal axis of the airplane. Therefore the pressure cabin is surrounded by skeleton-like arranged binders which enclose at least the pressure cabin corset-like. With little effort of material a frame-like support for the pressure cabin is formed.

Just the radial binders run rectangularly to the verge of the two half shells of the airplane body. Through the rectangular arrangement of the binders to the verges the parts of the airplane body are held together with minimal expenditure of force.

The radial binders are, according to an embodiment of the invention, designed in one piece, that means they consist of a tape which is joined at its ends. The transverse binders reach in an embodiment over the pressure cabin only partly in longitudinal direction. However, there is the possibility to arrange longitudinal binders (parallel to the longitudinal axis of the airplane) at the ends of the transverse binders which, for example, connect the transverse binders at the back pressure rib with the transverse binders of the front pressure rib. Thus the transverse binders consist of sections which are connected to each other.

It has turned out to be especially convenient that airplane body and binder consist of the same material. In this way a glueing of the binders with the airplane body by means of epoxy resin is absolutely possible. Besides the radial binders and traverse binders which embrace the pressure cabin furthermore longitudinal binders are provided at the airplane body which extend, for example, from the nose of the airplane body to the region of the tailplane. In this way not only the region of the pressure cabin is reinforced but also the complete airplane body. It has proofed to be particularly efficient also to connect the different binders, radial, longitudinal and/or transverse binders, at points where they cross each other. At these points several layers of binders are placed one upon the other. According to another embodiment of the invention it is provided to arrange not only one layer of a binder at the airplane body but, perhaps, two or three layers one upon the other so that an even better reinforcement of the airplane body becomes possible. The binder may also be guided along the verge of the two parts of the airplanes wherein these binders are embraced additionally by radial binders. In another embodiment of the invention it is provided that, for example, longitudinal binders are partly divided longitudinally, that means a part of the longitudinal binder extends from the front tip of the airplane body to its end, and the other part of the longitudinal binder encircles the airplane body in the region of the pressure cabin. Along the longitudinal axis of the pressure cabin thus the two parts of the longitudinal binder are supported by the outside of the airplane body, wherein at the end of the pressure cabin a part of the longitudinal binder is introduced into the interior of the airplane, and, if necessary, is guided out again on the opposite side.

According to the invention the skeletal structure of the reinforcement is arranged on the outside of the pressure cabin or partly on the outside of the airplane body, and is supported on the surface of the airplane body. By means of the thickness of the binders in the range of about one to five millimeters between the edges of the binders and the surface of the airplane body a shoulder is formed which is smoothed in order to keep the flow resistance low.

According to another advantageous modification of the invention on the exterior surface of the airplane body indentations are provided the width and depth of which correspond roughly with the dimensions of the binder. Thus the binders do not project beyond the surface of the airplane body. The gap forming between the edges of the binders and the edge of the indentation is also smoothed. Also the recesses which are provided for threading, for example, the transverse binders from the inside of the airplane body to the outside are closed with knifing filler.

The arrangement of the binders at the airplane body is such that openings like doors, windows and the like are arranged in the region between the different binders. As the upper verge of the door is arranged as a rule, higher than the upper verge of the windows it is, however, also possible to arrange the longitudinal binders in different planes, that means in the region of the opening of the door the longitudinal binder is guided above the upper verge of the door, and in the region of the windows, for example, a bit lower. In order to reinforce, for example, the fastening point for the wings, also two radial binders enclosing one window are lead together in the region of the wings. In the upper region of the airplane body the two radial binders are arranged spaced, and in the lower region these two radial binders are close to each other. The optimal embodiment of this skeletal reinforcement is two binders which cross each other at a right angle. Because of the shape of the airplane body, however, other arrangements of the binders are necessary which take the shape of the airplane body into consideration.

Besides the design of the airplane body, with the invention also the method for manufacturing the airplane body is claimed. The manufacturing of an airplane body of this type from at least two, in particular synthetic, parts comprises, first of all, the step to produce the single parts of the airplane body. This is done, for example, in the laminating process, in particular, in a hand laminating process where fleeces saturated with epoxy resin are glued one upon the other in a mould. After hardening of these parts of the airplane body they are assembled and glued together at their verges (these are, for example, flanges). At least at the connection regions of both parts together the verges are covered by reinforcements. The reinforcements consist conveniently of binders which are also glued to the airplane body. Binder and airplane body consist advantageously of the same material so that for glueing of binder and airplane body also epoxy resin may be used. It has turned out to be convenient to wrap the combined parts of the airplane body with binders, for that purpose radial, transverse and/or longitudinal binders are used. These binders form a skeleton which reinforces the outside of the airplane body, in particular the pressure cabin. These binders may be on top of the surface of the airplane body, or they are inserted in indentations in the surface of the airplane. The shoulders which occur between the edges of the binders and the surface of the airplane body or the edge of the indentation are smoothed after that so that no dents remain on the surface of the airplane body. The recesses for guiding out the transverse binders from the interior of the airplane body to the outside are also smoothed.

In this connection it is in particular pointed out that all features and characteristics but also methods described with reference to the airplane body accordingly may be transferred also with reference to the formulation of the method according to the invention, and can be used in the sense of the invention, and are seen also as disclosed. The same goes vice versa, that means all constructive that means device, characteristics mentioned only with reference to the method may also be taken into consideration, in the frame of the claims of the airplane, and be claimed, and also count as part of the invention and disclosure.

### SHORT DESCRIPTION OF THE DIFFERENT VIEWS OF THE DRAWINGS

In the following the invention is described in detail by means of a drawing. In the drawing:

FIG. 1 a cutout of an airplane body according to the invention in a side view;

FIG. 2 a three-dimensional view of the binders as they surround the fuselage, according to the invention;

FIG. 3 a view of a rib of an airplane body, according to the invention, and

FIG. 4 a three-dimensional view of an airplane body, according to the invention, with the side part removed.

### DETAILED DESCRIPTION OF THE PREFERRED EMBODIMENTS

The fuselage 2 of an airplane 1 shown in the figures comprises two pre-fabricated, synthetic half shells 21 the connection plane of which is orientated vertically along the longitudinal axis of the airplane 1. Thus the fuselage 2 consists of a right and a left half shell 21 as the parts from which the fuselage 2 is manufactured. According to this embodiment the half shells 21 are structured in multiple layers, and are laminated in a mould. After finishing the two half shells 21, they are connected to each other by glueing.

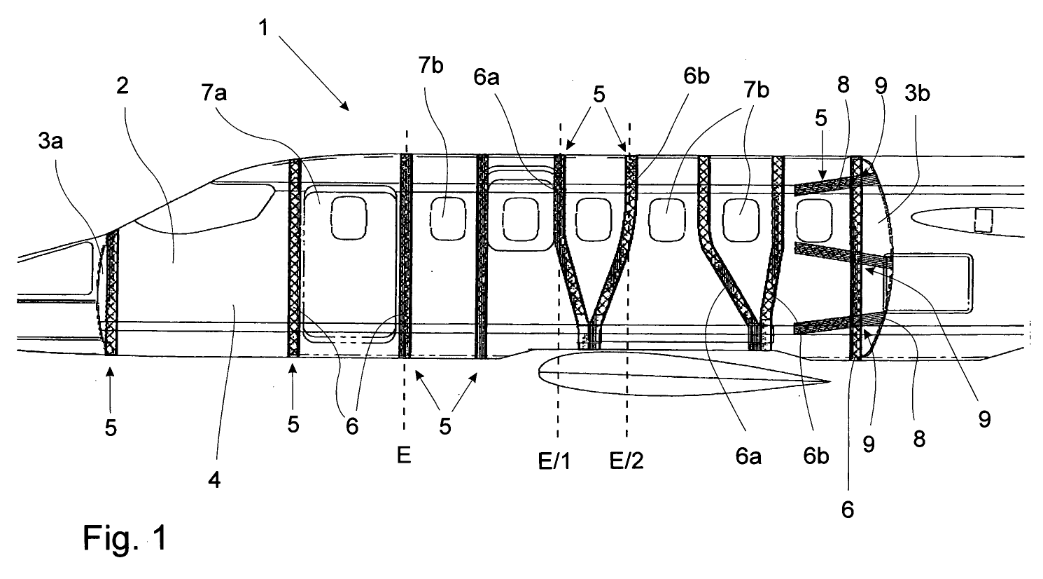

For reinforcing the fuselage 2 ribs 3 are provided at the fuselage 2. In particular the pressure cabin 4 is closed at its front and back end by pressure ribs (3a, 3b). The pressure cabin 4 is a self-contained space. It is not necessary to provide the entire interior of the fuselage 2 with pressure. According to the invention, in particular with a synthetic fuselage 2, in the region of the pressure cabin 4 a reinforcement 5 is provided so that the fuselage 2 of the airplane 1 in the region of the pressure cabin 4 is not destroyed because of the pressure difference between interior and exterior pressure. This reinforcement 5 consists of binders 6, 8 which encircle, in the embodiment according to FIG. 1, the fuselage 2 in transverse direction to the longitudinal axis of the airplane or to the airplane body. These binders 6 are called in the following radial binders 6. At the end of the pressure cabin 4 the pressure rib 3b is reinforced by transverse binders 8 which are guided from the interior of the fuselage 2 through recesses 9 to the outside of the fuselage 2. The binders 6, 8 are glued to the fuselage 2.

Advantageously these binders 6, 8 consist of carbon fiber reinforced synthetic laminate. This synthetic laminate can be loaded very strongly with tension, and the binders 6, 8 enclosing thus the fuselage 2 keep the pressure cabin 4 together. The wall of the fuselage 2 is reinforced by these binders 6. Carbon fiber reinforced synthetic materials are essentially lighter compared with metal. In particular lowering the weight is decisive in airplane engineering. Conveniently the material of the binders 6, 8 is the same as the material of the fuselage 2.

In FIG. 1 it can be seen that the binders 6, 8 are arranged only in the region of the fuselage 2 which do not carry openings /, for example for doors 7a and windows 7b. In the optimal embodiment the binders 6 wrap the fuselage 2 in a plane E. This is the shortest distance to enclose the fuselage and the mechanically most stable one.

As it can be seen, the binders 6a and 6b are also arranged in such a way that they encircle the fuselage 2 in different planes E/1, E/2. In the upper region the binders 6a, 6b are spaced, and in the bottom region the two binders 6a, 6b are close together, for example in order to reinforce the fastening point for the wing. Between the binders 6a, 6b the opening 7b for a window is provided which is enclosed partly by the binders 6a, 6b.

At the end of the pressure cabin 4 at the back rib 3b the binders 8 are orientated in such a way that they embrace the rib 3b essentially horizontally or vertically. The ends of the binders 8 are bent and reach over the fuselage 2 at least partly in longitudinal direction.

As the binders 6, 8 are arranged on the outside of the fuselage 2 these binders 8 are guided in the region of the ribs 3b to the outside from the interior of the fuselage 2 through pre-fabricated recesses 9. After finishing the airplane these recesses 9 are covered. Alternatively, these binders 8 may also be connected with longitudinal binders arranged at the inside at the fuselage 2.

The width of the binders 6, 8 is dimensioned in such a way that the binders 6, 8 can be arranged in the interval between the openings 7, for example the windows 7b and the doors 7a. The maximum width thus corresponds with the minimum distance between two openings 7.

However, it has turned out to be convenient to produce binders 6, 8 with a width of about 5 cm to 20 cm, preferably 10 cm. These binders 6, 8 reinforce the pressure cabin 4 sufficiently.

In an embodiment the binders 6, 8 are glued to the surface of the airplane fuselage 2, wherein as glue conveniently a synthetic resin, for example epoxy resin, is used.

According to another advantageous embodiment in the fuselage 2 indentations are provided for holding the binders 6, 8. In this way the binders 6, 8 are guided on the fuselage, and do not project beyond the surface of the fuselage 2. The shoulder or gap remaining between the edge of the binders 6, 8 is, after that, smoothed so that the surface of the airplane 1 is smooth.

The thickness of the binders 6, 8 is in a range between 1 to 5 mm. However, it has turned out to be convenient to design the binders 6, 8 with a thickness of 2 mm. This leads to a sufficient stability of the pressure cabin 4. The depth of the indentation is advantageously adapted to the thickness of the binders 6, 8.

The binders 6, 8 are conveniently built from the same material as the parts of the airplane body 2. These consist, for example, of a synthetic fiber composite structure where, for example, a multilayer fleece from carbon, glass or aramide fibers is saturated with epoxy resin. Aluminium threads integrated in the binders 6, 8 offer a lightning protection.

In FIG. 1 another arrangement of binders is shown. According to this example besides the radial and transverse binders 6, 8 also longitudinal binders 10a and 10b, 12 to 14 are provided which are arranged parallel to the longitudinal axis. The longitudinal binders 10a extend, for example, from the back region of the pressure cabin (not shown) essentially parallel to the longitudinal axis to the front pressure rib (not shown) of the pressure cabin.

The binders 12 and 13 project over the front pressure rib 3a, and reinforce at the same time the nose of the airplane.

The back ends of the longitudinal binders may be clamped over the back rib 3b, or they run further on the surface of the fuselage 2 to the back region of the airplane 1. The longitudinal binder 14 is in the back region of the fuselage attached a bit lower than in the front region. This arrangement is, for example, caused by the arrangement of the door 7a which is provided in the region between the two binders 6a, 6b. In the region between the two transverse binders 6a, 6b the longitudinal binder 14 runs above the opening (not shown) of the door 7a, while the window 7b is arranged, for example, a bit lower so that the longitudinal binder 14 in the region of the transverse binders 6c, 6d may be arranged a bit lower. The longitudinal binders embrace here, according to the invention, the airplane body 2 consisting of two parts as well as only one part of the airplane body. In this modification an improvement of stability is reached.

As described the longitudinal binders are designed suitably extended to the front and back so that, for example, in the region of the pressure cabin a separation of the longitudinal binder is the result in such a way that a part of the binder is extended to the back or to the front, and the other part wraps the pressure cabin 4. Such an embodiment is possible without any problems by the design of the binder in the described laminate structure.

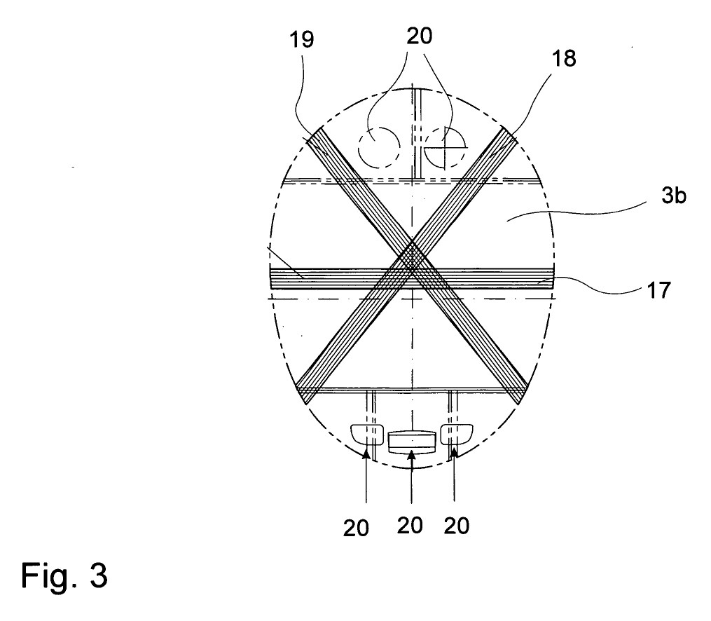

FIG. 3 shows one of the pressure ribs, for example the back rib 3b, in a top view, the longitudinal binders reaching over the rib diagonally. The longitudinal binders 17, 18 and 19 are arranged to one another in such a way that they form an angle with each other in the region of the rib 3b. The openings, elevations or indentations 20 shown in FIG. 3 are not covered by the binders 17, 18 and 19.

After finishing the airplane body 2 the synthetic body is hardened at about 80° C. By means of the invention thus a stable construction is manufactured in order to be also able to manufacture airplanes 1 with pressure cabins 4 made from synthetic material in the hand laminating method (not in the autoclave).

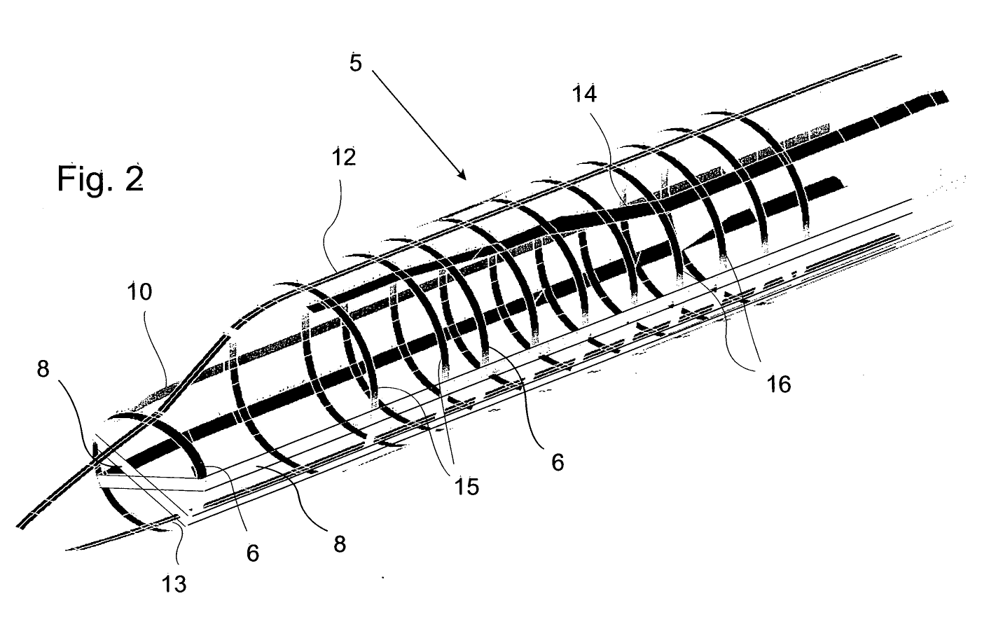

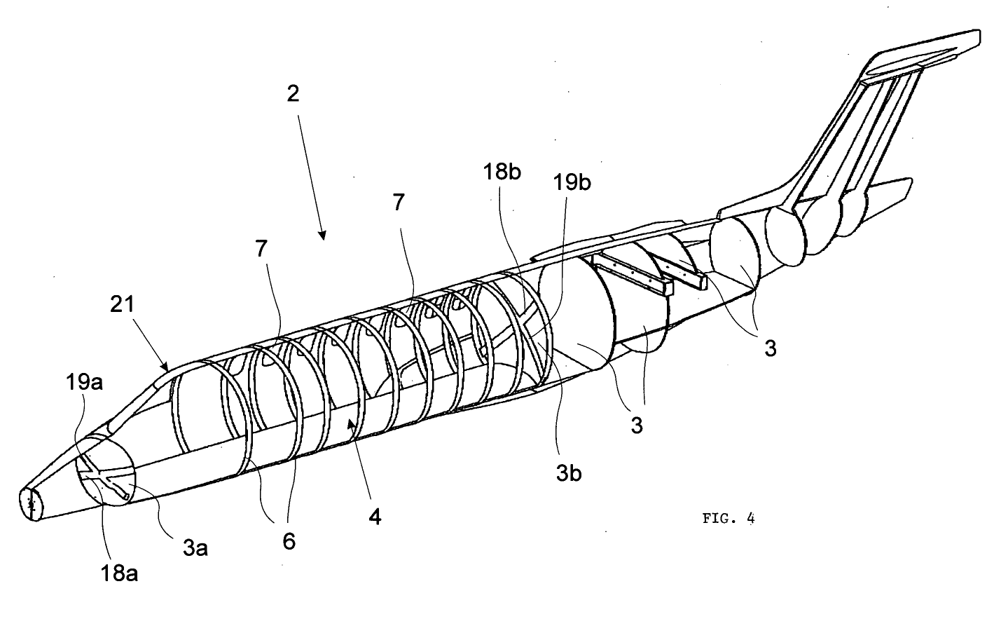

In FIG. 4 the airplane according to the invention is shown in a part view. This airplane body 2 consists of a half shell 21 of laminated synthetic layers. In this half shell 21, for example, the windows 7b already are already left open, and the transverse binders 6 extend around the airplane body 2 between the windows 7. The floor plane 22 of the finished fuselage is already provided in the half shell 21. Furthermore in the airplane body 2 ribs 3 can be seen which stabilise the airplane body 2. These ribs 3 are provided over the entire region of the airplane body 2, and extend to the tailplane of the airplane 1. In particular the region where the pilot and the passengers are is closed at both ends with the pressure ribs 3a, 3b, and forms together with a part of the airplane body 2 the pressure cabin 4. Longitudinal ribs are not shown in this figure, they can only be seen in the region of the ribs 3a and 3b, however, they extend, as shown in FIG. 2, parallel to the longitudinal axis of the airplane.

The invention is described in particular in connection with the design of an airplane body in synthetic construction (fiber reinforced synthetic composite with epoxy resin). However, the invention is not restricted to that. The result according to the invention may also be reached in the same way with airplane bodies which consist of another material (for example metal, light metal and so on), or composite materials (for example different materials of the part and the reinforcement).

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. An airplane body, in particular fuselage, comprising at least two parts manufactured preferably from synthetic material wherein the parts are joined to each other at their verges and the airplane body or the parts is/are provided at least partially with a reinforcement.

2. The airplane body according to claim 1, characterised in that the reinforcement (5) is formed by at least one binder which encircles the airplane body, the binder being orientated radially, longitudinally and/or transversely to the longitudinal axis of the airplane body).

3. The airplane body according to claim 1, characterised in that the reinforcement runs angularly, in particular rectangularly, to the verge, and, in particular, reaches over the edges of the adjoining parts.

4. The airplane body according to claim 1, characterised in that the binder consists of parts or is designed continuously or in one piece.

5. The airplane body according to claim 1, characterised in that the airplane body consists of two pre-fabricated half shells.

6. The airplane body according to claim 1, characterised in that the airplane body consists of two pre-fabricated half shells and the connection plane of the half shells is arranged vertically along the longitudinal axis of the airplane body.

7. The airplane body according to claim 1, characterized in that the airplane body consists of two pre-fabricated half shells and the half sells have a multilayer structure.

8. The airplane body according to claim 1, characterised in that the airplane body consists of two pre-fabricated half shells and the half shells are manufactured by laminating, in particular laminating in a mould.

9. The airplane body according to claim 1, characterized in that in the airplane body a pressure cabin is provided which is closed at least at one end by a part designed as pressure rib.

10. The airplane body according to claim 1, characterized in that in the airplane body a pressure cabin is provided and the reinforcement is provided in particular in the region of the pressure cabin.

11. The airplane body according to claim 1, characterised in that the reinforcement is formed by a binder, and the binder consists of a fiber reinforced, in particular carbon fiber reinforced, synthetic laminate.

12. The airplane body according to claim 1, characterized in that airplane body and the reinforcement designed as binder consists of the same material.

13. The airplane body according to claim 1, characterised in that the reinforcement is formed by a binder, and the radially running binder is arranged between openings like doors or windows of the airplane body.

14. The airplane body according to claim 1, characterised in that the reinforcement, in particular the binder, runs at least partly in several planes which form different angles with the longitudinal axis of the airplane body.

15. The airplane body according to claim 1, characterised in that the reinforcement, in particular several binders, is arranged in several planes in the region of the verges of the adjoining parts.

16. The airplane body according to claim 1, characterised in that the reinforcement is formed by a binder, and at least two binders are arranged on one part one above the other, and are connected with each other.

17. The airplane body according to claim 1, characterised in that the reinforcement, in particular the binder, is arranged on the outside of the airplane body.

18. The airplane body according to claim 1, characterized in that in the airplane body recesses are provided.

19. The airplane body according to claim 1, characterized in that the reinforcement as binder is introduced entirely or partly at the ends of the pressure cabin in the airplane body.

20. The airplane body according to claim 1, characterized in that the reinforcement is designed as binder, and the radially, longitudinally and/or transversely running binders are connected with each other.

21. The airplane body according to claim 1, characterised in that the reinforcement is designed as binder, and the width of the binders is about 5 to 20 cm, preferably 10 cm, and the thickness of the binders is about 1 to 5 mm, preferably 2 mm.

22. The airplane body according to claim 1, characterized in that the reinforcement is designed as binder, and the binder is connected, in particular glued, with the parts of the airplane body.

23. The airplane body according to claim 1, characterised in that the reinforcement is designed as binder, and as glue for connecting the binder with the part the glue of the synthetic laminate is used.

24. The airplane body according to claim 1, characterised in that the reinforcement is designed as binder, and as glue for connecting the binder with the part the glue of the synthetic laminate is used, and as glue epoxy resin is provided.

25. The airplane body according to claim 1, characterised in that the binder is arranged in an indentation provided in the part of the airplane body.

26. The airplane body according to claim 1, characterised in that the reinforcement is designed as binder, and a shoulder or gap forming between the edge of the binder and the part is filled with knifing filler.

27. The airplane body according to claim 1, characterised in that the reinforcement is designed as binder, and at least one binder encloses the pressure cabin completely.

28. The airplane body according to claim 1, characterised in that the reinforcement is designed as binder, and the longitudinal binders are divided.

29. The airplane body according to claim 1, characterised in that the reinforcement is designed as binder, and a part of the longitudinal binder is guided into the airplane body, encloses the end of the pressure cabin or the pressure rib, and the other part is guided further on the surface of the airplane body.

30. A method for manufacturing an airplane body, in particular a fuselage, consisting of at least two parts, characterised by the sequence of the following steps:
Manufacturing the parts of the airplane body
Combining the parts
Connecting the parts at their verges
Covering the connection region of the verges of adjoining, combined parts by reinforcements,
or characterised by wrapping the combined parts with binders, the binders being orientated radially, transversely and/or longitudinally to the longitudinal axis of the airplane body.

31. The method according to claim 30, characterised in that the reinforcement or the binder is connected with the parts of the airplane body by glueing.

32. The method according to claim 30, characterised in that radially, transversely and/or longitudinally running binders are connected with each other.

33. The method according to claim 30, characterised by smoothing dents on the surface of the airplane body provided with binders.
